(19) United States
(12) Patent Application Publication
(10) Pub. No.: US 2017/0055143 A1
(43) Pub. Date: Feb. 23, 2017

(54) METHOD AND SYSTEM FOR PROVIDING ADVERTISEMENTS TO A MOBILE DEVICE

(71) Applicant: Aaron Vacek, Truckee, CA (US)

(72) Inventor: Aaron Vacek, Truckee, CA (US)

(21) Appl. No.: 15/173,680

(22) Filed: Jun. 5, 2016

Related U.S. Application Data
(60) Provisional application No. 62/207,644, filed on Aug. 20, 2015.

(51) Int. Cl. H04W 4/24; G06F 3/0482; G06Q 30/02; H04M 15/00

(52) U.S. Cl. CPC H04W 4/24; H04M 15/39; G06F 3/0482; G06Q 30/0267

(57) ABSTRACT

A system for providing advertisements to a wireless user device (WUD) includes a (WUD), a carrier server (CS), and a business entity server (BES). The WUD includes a graphical user interface for rendering options and receiving a selection of an option. The WUD includes a processor for executing computer program instructions (CPI) and transmitting the selection as data to a CS via a communications network. The CS comprises a non-transitory computer readable storage medium (NCRSM) for storing CPI defined by modules of the system. The processor is communicatively coupled to the NCRSM to execute the CPI. A data communications module (DCM) receives the selection. An analysis module dynamically analyzes the selection and generates data variables. The DCM transmits the generated data variables and information to the BES and the WUD via the communications network. The WUD displays advertisements of a business entity and receives free wireless service.

### CROSS REFERENCE TO RELATED APPLICATIONS

This application claims the benefit of and priority to U.S. Provisional Application Ser. No. 62/207,644 entitled “FREE CELL PHONE SERVICE THROUGH (PAID FOR BY) ADVERTISING” filed on 20 Aug. 2015, the entirety of which is hereby incorporated by reference herein for all purposes.

### FIELD OF THE INVENTION

The invention disclosed herein relates generally to a method and system for providing advertisements to a mobile device. More particularly, the invention disclosed herein relates generally to a method and system for providing free wireless service to a wireless user device if a user agrees to view advertisements.

### BACKGROUND

Traditionally, advertising has gone through various mediums such as newspapers, magazines, billboards, television, internet, and recently through mobile advertising. Typically, something is offered for “free” if the consumer agrees to see paid-for-advertisements, for example, free television if a viewer views commercials, free video games if the ads in the game are viewed, etc. Conversely, for an advertisement-free viewing experience, the consumer would have to pay for a television show, movie, buy a video game, etc. Conventionally, advertising companies pay billions of dollars a year in an attempt to reach not just consumers, but also all the right consumers who will purchase their products. Consumers must pay in most media applications to have an ad-free viewing experience. Additionally, wireless data services are expensive for most consumers. A method, which provides benefits for consumers in conjunction with allowing advertising companies in reaching the right consumers, is thus required. Such a method would allow advertising entities to suitably plan and utilize their funds effectively.

Furthermore, existing methods displaying advertisements on wireless user devices require consumer interaction with the advertisement. Most advertisements provide interactive links, which proceed to take the user to the advertising company's website. Most users refrain from interacting with advertisements unless they are interested in a product. As interaction with the advertisement is mandatory to receive compensation, most users click on the links provided. This increases the time spent on viewing a single advertisement. A method of displaying advertisements, which requires no interaction from the user to compensate the user, is required. In other similar methods, users are compensated with money into their accounts if they view advertisements. Alternately, users are provided with plans or offerings from the carrier depending on the number of advertisements they view over a certain period. Both these approaches require the consumer to constantly view their accounts and verify the compensation credited or the plan expiry. In cases of emergency, if an account lacks the credit to use the wireless service, the user is at a disadvantage. A method, which uses a paid-in-full contract, is required.

Hence, there is a long felt but unresolved need for a method, which provides benefits for consumers in conjunction with allowing advertising companies in reaching the right consumers. Furthermore, there is a need for advertisements with minimal or no interaction required from the user. Moreover, there is a need for a method, which uses a paid-in-full contract. This would be the form of offering to pay cell phone contracts. The consumer would have to pay for cell phone service if they opt not to have advertisements streaming on their phone in the advertising space. The idea is that advertisements will reach their intended audience and market quickly and efficiently in order to bolster sales. The consumer will realize cost savings. Moreover, cell phone service providers/carriers will receive on time payments and potentially save money on loss mitigation, collections and user onboarding costs.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The system and method disclosed herein addresses the above-mentioned need for a method, which provides benefits for consumers in conjunction with allowing advertising companies in reaching the right consumers. Furthermore, the system and method disclosed herein addresses the need for advertisements with minimal or no interaction required from the user. Moreover, the system and method disclosed herein addresses the need for a method, which uses a paid-in-full contract. This would be the form of offering to pay cell phone contracts. The consumer would have to pay for cell phone service if they opt not to have advertisements streaming on their phone in the advertising space. The idea is that advertisements will reach their intended audience and market quickly and efficiently in order to bolster sales. The consumer will realize cost savings and cell phone service providers/carriers will receive on time payments and potentially save money on loss mitigation, collections, and user onboarding costs. The system and method disclosed herein for providing free wireless service subject to viewing of advertisements by a user comprises a wireless user device, a carrier server, and a business entity server. The wireless user device comprises a graphical user interface for rendering options and receiving a selection of an option by a user. Moreover, the wireless user device comprises at least one processor for executing computer program instructions and transmitting the received selection of the user as data to a carrier server via a communications network.

The carrier server is configured to receive the transmitted data from the wireless user device. The carrier server comprises a non-transitory computer readable storage medium and at least one processor. The non-transitory computer readable storage medium is configured to store computer program instructions defined by modules of the system. The processor is communicatively coupled to the non-transitory computer readable storage medium. The processor is configured to execute the computer program instructions defined by the modules of the system. The modules comprise a data communications module and an analysis module. The data communications module is configured to receive the transmitted selection of the user from the wireless user device. The analysis module is configured to dynamically analyze the selection of the user and generate data variables. The data communications module is further configured to transmit the generated data variables and information to a business entity server and the wireless user device via the communication network whereby the wireless user device is directed to display advertisements of a business entity. The wireless user device receives free wireless service if the selection of the user is a predetermined outcome. The business entity server is configured to receive the generated data variables and information from the data communications module of the carrier server.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 exemplarily illustrates a block diagram showing the components of a system for providing advertisements to a mobile device.

FIG. 2 exemplarily illustrates a method providing advertisements to a mobile device.

FIG. 3 exemplarily illustrates a schematic diagram showing the elements of the system.

FIG. 4 exemplarily illustrates a schematic diagram showing the elements of the system.

FIG. 5 exemplarily illustrates a graphical user interface of the wireless user device showing an advertisement space.

FIG. 6 exemplarily illustrates a graphical user interface of the wireless user device showing an advertisement space.

FIG. 7 exemplarily illustrates a graphical user interface of the wireless user device showing an advertisement space.

### DETAILED DESCRIPTION OF THE INVENTION

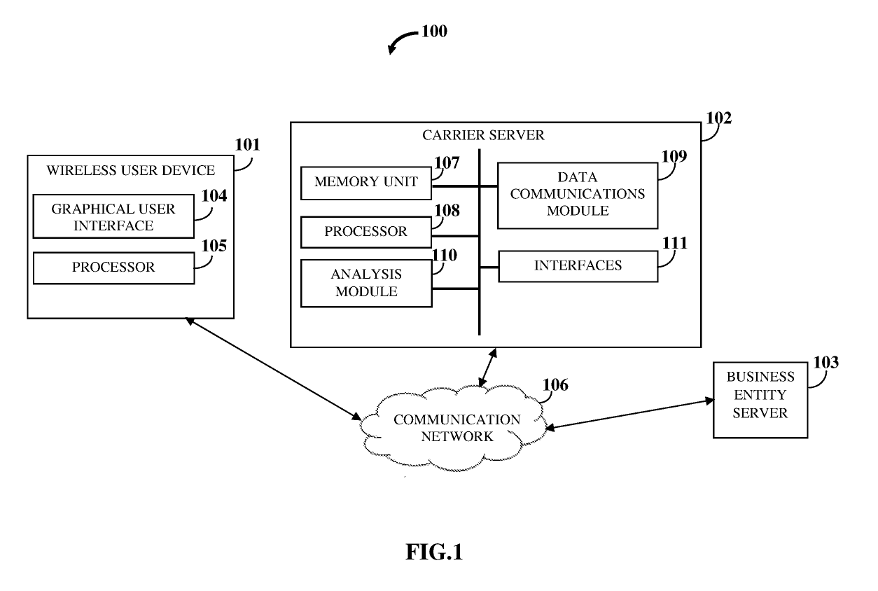

FIG. 1 exemplarily illustrates a block diagram showing the components of a system 100 for providing free wireless service subject to advertisements being viewed by a user. In an embodiment, the system 100 comprises a wireless user device 101, a carrier server 102, and a business entity server 103. As used herein, “carrier” refers to network service providers in general. Network service providers build, operate, and maintain the wireless network on which cellular phones and wireless PDAs operate. The carrier networks typically operate with very specific communication protocols, for example, GSM, TDMA, CDMA, etc. Selected examples of carriers include AT&T Wireless, Verizon Wireless, Sprint, T-Mobile, etc. The wireless user device 101 comprises a graphical user interface 104 for rendering options and receiving a selection of an option by a user. Moreover, the wireless user device 101 comprises at least one processor 105 for executing computer program instructions and transmitting the received selection of the user as data to the carrier server 102 via a communication network 106. The carrier server 102 is configured to receive the transmitted data from the wireless user device 101. The carrier server 102 comprises a non-transitory computer readable storage medium 107 and at least one processor 108. The non-transitory computer readable storage medium 107 is configured to store computer program instructions defined by modules of the system 100. The processor 108 is communicatively coupled to the non-transitory computer readable storage medium 107.

The processor 108 is configured to execute the computer program instructions defined by the modules of the system 100. The modules comprise a data communications module 109 and an analysis module 110. The data communications module 109 is configured to receive the transmitted selection of the user from the wireless user device 101. The analysis module 110 is configured to dynamically analyze the selection of the user and generate data variables. The data communications module 109 is further configured to transmit the generated data variables and information to a business entity server 103 and the wireless user device 101 via the communication network 106 whereby the wireless user device 101 is directed to display advertisements of a business entity. The wireless user device 101 receives free wireless service if the selection of the user is a predetermined outcome. The predetermined outcome refers to the user agreeing to view advertisements as specified by the agreement between the consumer and the business entity. That is, if a consumer signs up with the business entity to utilize the service, the business entity will only provide payments if the consumer actively receives and views advertisements on the wireless user device 101 of the consumer. The contract between the consumer and cell phone service provider still exists; however, a separate contract with the business entity will be required in order to utilize the service. The business entity server 103 is configured to receive the generated data variables and information from the data communications module 109 of the carrier server 102. The multiple interfaces 111 are, for example, one or more bus interfaces, a wireless interface, etc. As used herein, “bus interface” refers to a communication system that transfers data between components inside a computing device and between computing devices.

As used herein, the “computing device” is an electronic device, for example, a personal computer, a tablet computing device, a mobile computer, a mobile phone, a smartphone, a portable computing device, a laptop, a personal digital assistant, a wearable device such as the Google Glass™ of Google Inc., the Apple Watch® of Apple Inc., etc., a touch centric device, a workstation, a server, a client device, a portable electronic device, a network enabled computing device, an interactive network enabled communication device, a gaming device, a set top box, a television, an image capture device, a web browser, a portable media player, a disc player such as a Blu-ray Disc® player of the Blu-ray Disc Association, a video recorder, an audio recorder, a global positioning system (GPS) device, a theater system, any entertainment system, any other suitable computing equipment, combinations of multiple pieces of computing equipment including but not limited to artificial intelligence, virtual reality or holographic technology, etc.

In an embodiment, the electronic device is a hybrid device that combines the functionality of multiple devices. Examples of a hybrid electronic device comprise a cellular telephone that includes media player functionality, a gaming device that includes a wireless communications capability, a cellular telephone that includes game and electronic mail (email) functions, and a portable device that receives email, supports mobile telephone calls, has music player functionality, and supports web browsing. In an embodiment, computing equipment is used to implement applications such as media playback applications, for example, iTunes® from Apple Inc., a web browser, a mapping application, an electronic mail (email) application, a calendar application, etc. In another embodiment, computing equipment, for example, one or more servers are associated with one or more online services.

In another embodiment, the business entity server 103 is connected to the carrier server 102 via the communication network 106. The communication network 106 is a network, for example, the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, or any subsequent high speed data provider, etc., a local area network, a wide area network, an internet connection network, an infrared communication network, etc., or a network formed from any combination of these networks.

In an embodiment, the memory unit 107 stores the generated sensor data variables. The processor 108 is communicatively coupled to the memory unit 107. The processor 108 is configured to execute the computer program instructions defined by the different modules. The processors 108 and 105 refer to any one or more microprocessors, central processor (CPU) devices, finite state machines, computers, microcontrollers, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions.

In an embodiment, the processor 108 is implemented as a processor set comprising, for example, a programmed microprocessor and a math or graphics co-processor. The processor 108 is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The system 100 disclosed herein is not limited to employing a processor 108. In an embodiment, the multi-functional heat pump system 100 employs a controller or a microcontroller. The processor 108 executes the modules, for example, 109, 110, etc., of the system 100.

In an embodiment, the Entity/Business/Software Company, which offers to pay in individual Cell Phone Contracts results in and thereby offering “free” cell phone service to consumers who agree to the terms and use of service of said entity. This is accomplished through payments from businesses who wish to advertise to the aforementioned consumers. Consumers who agree to receive “free” wireless service must also agree to receive proprietary advertisements on the graphical user interface 104 of the wireless user device 101, for example, a cell phone's Home Screen and/or Locked Screen while the phone is on and not in “Sleep Mode” or in any other hibernating state. This “Advertising Space” will be reserved for displaying various proprietary advertisements from paying business entities who wish to advertise through this medium.

In an embodiment, the business entity server 103 is replaced by a software company server, which provides an application software, which is downloaded to the wireless user device 101 via the communications network 106. The application software developed by the software company manages the advertisements that must be developed to fit within the advertising space on the graphical user interface 104 of the wireless user device 101. The application software operates on any wireless user device 101 that has access to the communication network 106 regardless of the carrier entity. In an embodiment, the proprietary advertisement space occupies no less than 10% of the graphical user interface 104 of the wireless user device 101 while not in sleep mode or otherwise hibernating state. The consumer need not select or enter an application in order for advertisements to be displayed. Proprietary advertisements are displayed within the advertising space continuously. In an embodiment, the advertisements are displayed on a predetermined space on the graphical user interface 104 of the wireless user device 101. The consumer determines how the advertising space is displayed on the graphical user interface 104, for example, a square advertising space, a banner, which runs on the top, bottom, or side of the phone, or other visible representation, which occupies no less than 10% of the graphical user interface 104. In an embodiment, once the user has agreed to view the advertisements, he/she cannot hide the advertisement space.

Furthermore, the advertisement space does not appear on any “in-app” application. Once the user navigates away from the Home Screen, the advertising space is not visible as to not hinder the use of any other apps. Once the consumer navigates back to the Home Screen and/or Locked Screen, the advertising space is visible. The consumer will have the option to select an advertisement on their smartphone and the application will navigate the consumer to that advertisement's web page, URL, or other designated location, which is designated by the paying advertising customer. Additionally, the user has the option to like or dislike a particular ad. A “like” from the consumer leaves that particular advertisement in circulation on their wireless user device 101. The information is provided back to the advertising customer via the business entity server 103. A “dislike” from the consumer may remove a particular ad from circulation on the wireless user device 101; however, another advertisement takes its place. The information is also provided back to the advertising customer via the business entity server 103. A “dislike” does not create a void in the advertising circulation, but it may remove a particular ad and replace it with another ad of possible interest to the user. The above-mentioned interactive advertisements are an embodiment. In the preferred embodiment, the advertisements do not require user interactions. Additionally, the wireless service provided free is not dependent on a credit-based system. In the preferred embodiment, the user buys his own wireless user device 101 but the wireless service is provided free based on the selection of the user.

In the method disclosed herein, the advertising/business entity signs a contract with a carrier whereby the business entity pays the carrier. The carriers thus receive complete on time payments. The consumer benefits by receiving free wireless service. The business entity benefits by limiting spending and reaching the right customers with lower budgets. Customized ads are supplied to the wireless user device 101 of individual users. User preferences enable the advertising entities to plan their spending on advertisements more effectively and increase sales of advertised products. The method disclosed herein is a paid-in-full contract service, which is operated independently of a cell phone service provider/carrier. The method does not require additional plan offerings from the service provider and does not require consumer interaction, though the option to interact with advertisements is available as an embodiment. The only requirement from the user is the agreement with the contract paying company (carrier) to agree to receive proprietary advertisements in return for their cell phone bill/contract being paid. The user does not receive compensation or credits for viewing advertisements, the user's contract is paid-in-full. Additionally, a standardized format for collecting cell phone contract data in order to pay cell phone service providers/carriers must be created. In an embodiment, an option to pay the cell phone service provider directly via a third party payment gateway is provided. In another embodiment, a screen scrubbing software, for example, an optical character recognition (OCR) software, etc., is used to collect pertinent payment information from consumer downloads from a business entity's website.

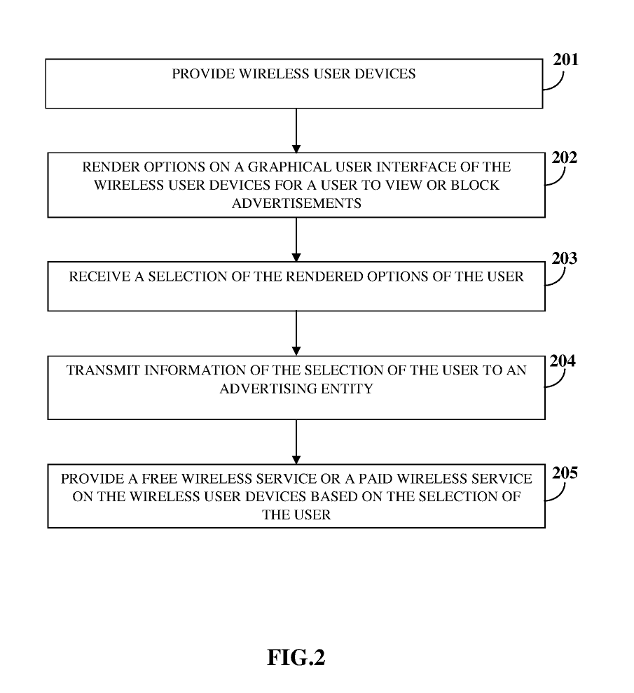

FIG. 2 exemplarily illustrates a method for providing free wireless service subject to advertisements being viewed by a user. In the method disclosed herein, wireless user devices 101 are provided 201. Options are rendered 202 on a graphical user interface 104 of the wireless user device 101. A user is provided the option of viewing advertisements for receiving free wireless service. The user is also given the option to block or not view specific advertisements. A selection of the rendered options of the user is received 203 by the system 100. The selection of the user is transmitted 204 to an advertising entity. Finally, free wireless service is provided 205 to users who choose to view advertisements. Conversely, a paid wireless service is provided 205 to users who choose to not view the advertisements.

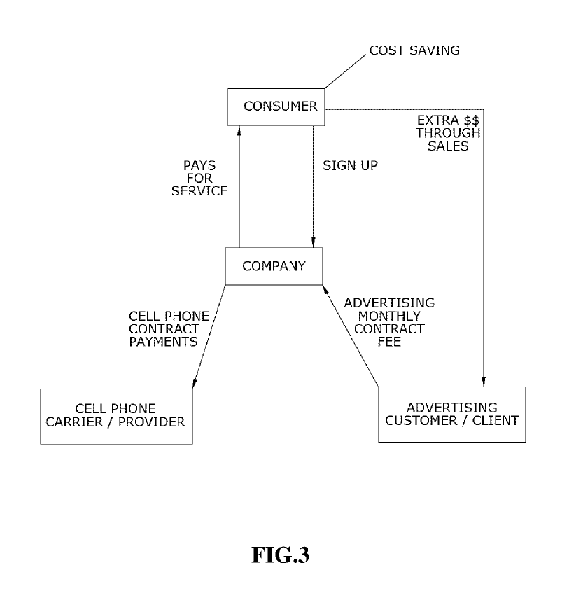

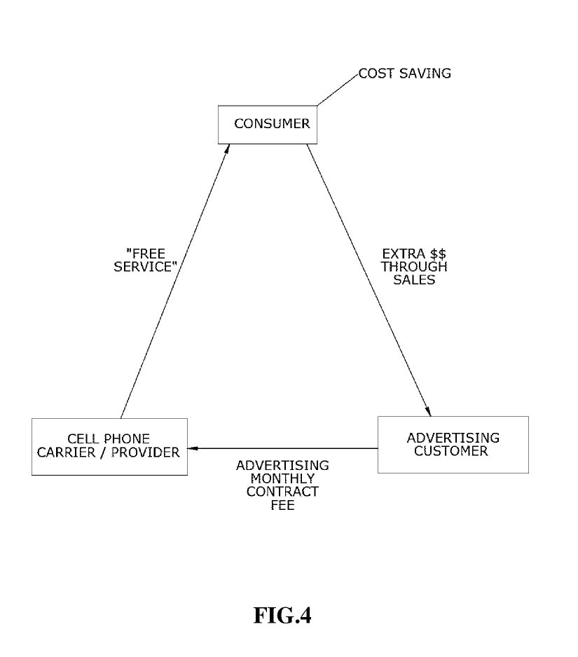

FIG. 3 exemplarily illustrates a schematic diagram showing an embodiment of the system 100 and method. In the embodiment, a company, for example, a product company, a software company signs a contract with the carrier agreeing to pay for consumers who sign up with the company. The company also signs a monthly contract with an advertising client agreeing to display his/her advertisements to the wireless user device 101 of the consumer who signed up with the company. As a result, the cell phone carrier receives payment from the company and there are no late payments or dues to be settled. Furthermore, the consumers get the benefit of using free services provided by the carrier, for example, free data services, voice services, etc. The advertising company records improved sales as more consumers interested in their products are reached. FIG. 4 exemplarily illustrates a schematic diagram showing an embodiment of the system 100 and method, which would be reflective of a licensing model by the business entity to the carriers to use as a service with their consumers directly. In the embodiment, the carrier signs a monthly contract with the advertising customer agreeing to display his/her advertisements to consumers subscribed to the carrier service. The advertising customer pays the carrier a monthly fee. The carrier also signs a contract with the consumer agreeing to provide him/her with free wireless service if the consumer views advertisements provided by the carrier. Even in this model, the consumer benefits by freely accessing the services provided by the carrier. The advertising client achieves higher sales with more consumers being reached.

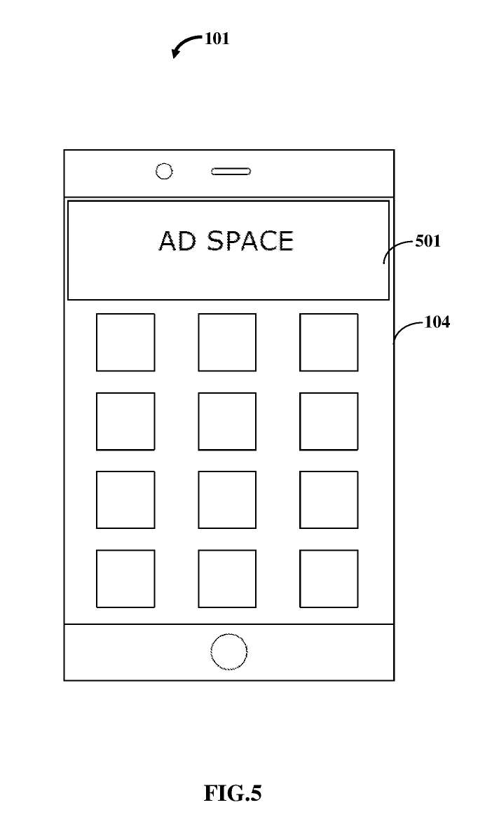

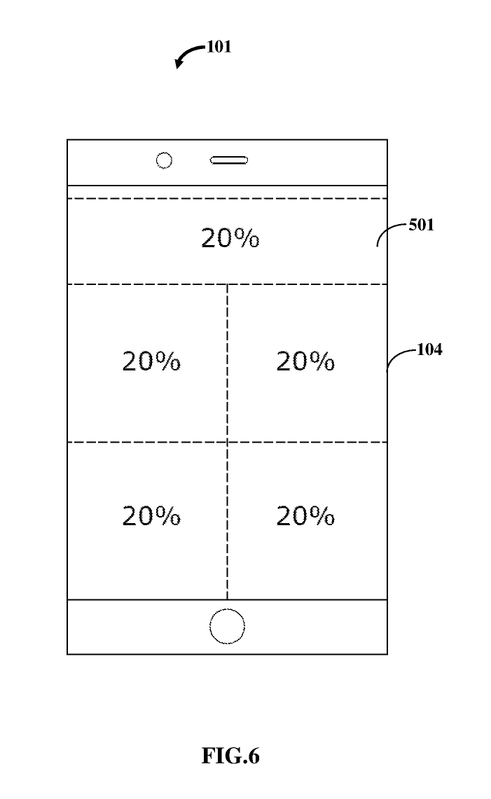

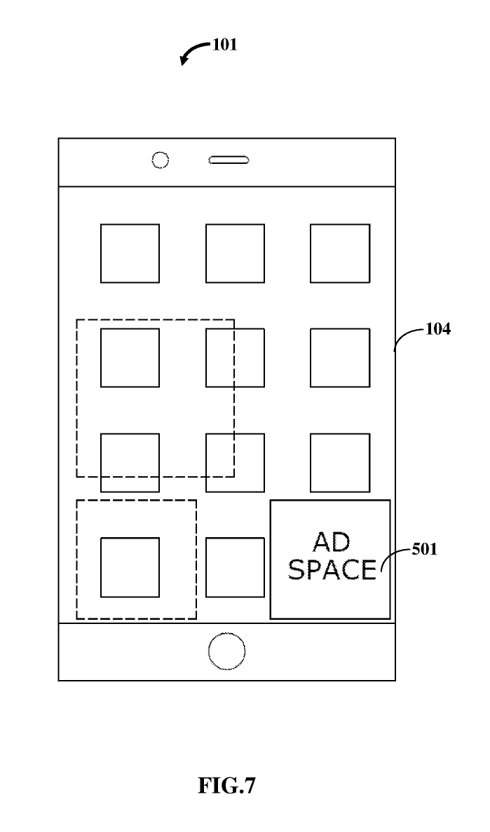

FIG. 5 exemplarily illustrates a graphical user interface 104 of the wireless user device 101 showing an advertisement space 501. FIG. 6 exemplarily illustrates a graphical user interface 104 of the wireless user device 101 showing an advertisement space 501. FIG. 7 exemplarily illustrates a graphical user interface 104 of the wireless user device 101 showing an advertisement space 501. In an embodiment, the advertisements are displayed when the graphical user interface 104 displays a home screen or a lock screen. Additionally, the advertisements are not displayed when the user engages the wireless user device 101 in an activity, for example, in-app activity, playing media, etc. The advertisements are displayed on a predetermined space 501 on the graphical user interface 104 of the wireless user device 101 as exemplarily illustrated in FIGS. 5-7. The system 100 allows the user to determine the positioning of the space 501 on the graphical user interface 104 according to his/her preference. In an embodiment, the advertising space 501 occupies no less than 10% of the graphical user interface 104 of the wireless user device 101.

It will be readily apparent in different embodiments that the various methods, algorithms, and computer programs disclosed herein are implemented on non-transitory computer readable storage media appropriately programmed for computing devices. The non-transitory computer readable storage media participates in providing data, for example, instructions that are read by a computer, a processor or a similar device. In different embodiments, the “non-transitory computer readable storage media” further refers to a single medium or multiple media, for example, a centralized database, a distributed database, and/or associated caches and servers that store one or more sets of instructions that are read by a computer, a processor or a similar device. The “non-transitory computer readable storage media” further refers to any medium capable of storing or encoding a set of instructions for execution by a computer, a processor or a similar device and that causes a computer, a processor or a similar device to perform any one or more of the methods disclosed herein. Common forms of non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft®.NET, Objective-C®, etc. Other object-oriented, functional, scripting, and/or logical programming languages can also be used. In an embodiment, the computer program codes or software programs are stored on or in one or more mediums as object code. In another embodiment, various aspects of the system 100 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the system 100 disclosed herein are implemented as programmed elements, or non-programmed elements, or any suitable combination thereof.

The method and the system 100 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The method and the system 100 disclosed herein are not limited to a particular computer system platform, processor, operating system, or network. In an embodiment, one or more aspects of the method and the system 100 disclosed herein are distributed among one or more computer systems, for example, servers configured to provide one or more services to one or more client computers, or to perform a complete task in a distributed system. For example, one or more aspects of the method and the system 100 disclosed herein are performed on a client-server system that comprises components distributed among one or more server systems that perform multiple functions according to various embodiments. These components comprise, for example, executable, intermediate, or interpreted code, which communicate over a network using a communication protocol. The method and the system 100 disclosed herein are not limited to be executable on any particular system or group of systems, and are not limited to any particular distributed architecture, network, or communication protocol.

The foregoing examples have been provided merely for the purpose of explanation and are in no way to be construed as limiting of the method and the system 100 disclosed herein. While the method and the system 100 have been described with reference to various embodiments, it is understood that the words, which have been used herein, are words of description and illustration, rather than words of limitation. Further, although the method and the system 100 have been described herein with reference to particular means, materials, and embodiments, the method and the system 100 are not intended to be limited to the particulars disclosed herein; rather, the method and the system 100 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the system 100 disclosed herein in their aspects.

What is claimed is:

1. A system for providing advertisements to a wireless user device comprising:
a wireless user device comprising a graphical user interface for rendering options and receiving a selection of an option by a user, wherein the wireless user device comprises at least one processor for executing computer program instructions and transmitting the received selection of the user as data to a carrier server via a communications network;
the carrier server configured to receive the transmitted data from the wireless user device, the carrier server comprising:
a non-transitory computer readable storage medium configured to store computer program instructions defined by modules of the system; and
at least one processor communicatively coupled to the non-transitory computer readable storage medium, the at least one processor configured to execute the computer program instructions defined by the modules of the system, the modules comprising:
a data communications module configured to receive the transmitted selection of the user from the wireless user device;
an analysis module configured to dynamically analyze the selection of the user and generate data variables; and
the data communications module further configured to transmit the generated data variables and information to a business entity server and the wireless user device via the communication network whereby the wireless user device is directed to display advertisements of a business entity and receives free wireless service if the selection of the user is a predetermined outcome; and
the business entity server configured to receive the generated data variables and information from the data communications module of the carrier server.

2. The system of claim 1, wherein the advertisements are displayed when the wireless user device is in one of a home screen mode and a lock mode.

3. The system of claim 1, wherein the advertisements are not displayed when the user engages the wireless user device in an activity.

4. The system of claim 1, wherein the advertisements are displayed on a predetermined space on the graphical user interface of the wireless user device.

5. The system of claim 4, wherein the predetermined space on the graphical user interface is determined by the user.

6. A computer implemented method for providing advertisements to a wireless user device, the computer implemented method comprising:
providing wireless user devices;
rendering options on a graphical user interface of the wireless user devices for a user to one of view and block advertisements;
receiving a selection of the rendered options of the user;
transmitting information of the selection of the user to an advertising entity; and
providing one of a free wireless service and a paid wireless service on the wireless user devices based on the selection of the user.

7. The computer implemented method of claim 1, further comprising displaying advertisements based on the selection of the user.

8. The computer implemented method of claim 1, wherein the advertisements are rendered on one or more sections of the graphical user interface of the wireless user devices based on preferences of the user.
